(19) United States
(12) Patent Application Publication
(10) Pub. No.: US 2012/0048127 A1
(43) Pub. Date: Mar. 1, 2012

(54) DUAL-FILTER CUTTER ROTARY DISC OF JUICER

(76) Inventors: Chin-I HUANG, Antin Shiang (TW); Chih-Neng Chung, Antin Shiang (TW)

(21) Appl. No.: 12/870,810

(22) Filed: Aug. 28, 2010

(51) Int. Cl. A23N 1/02

(52) U.S. Cl. 99/503

(57) ABSTRACT

The present invention relates to a juicer, and more particularly to a dual-filter cutter rotary disc for the juicer, which includes a base coupled to the juicer. The base includes two filter nets which are synchronously rotated along with the base and at least one cutter. The two filter nets are an inner filter net and an outer filter net. The two filter nets have meshes which are different in configuration, in shape and in size, so that the two filter nets have different operative filter areas. In this way, the smaller meshes of the inner filter net can filter larger fibers, so the pomace in the juice is less. The meshes of the outer filter net can get a higher juice yield to keep the flavor of fruit. Hence, the present invention achieves a dual-filter effect. The different filter nets can be separated for a desired filter, providing a better filter efficiency and quality.

### BACKGROUND OF THE INVENTION

1. Field of the Invention

The present invention relates to a juicer, and more particularly to a dual-filter cutter rotary disc of a juicer.

2. Description of the Prior Art

As everyone knows, a juicer is an essential home appliance. A conventional juicer comprises a base. The base comprises a motor and a cutter rotary disc driven by the motor. When in use, the food is pressed into the cutter rotary disc. The food is cut and ground by the cutter in the cutter rotary disc to express juice from a filter net around the cutter rotary disc.

There are various juicers on the market. A juicer with a cutter rotary disc having two filter nets is developed recently. However, the meshes of the inner filter and the outer filter net of this juicer have the same configuration. Although this juicer can is provide a dual-filter effect, there are still some shortcomings existed. The same meshes of the inner and outer filter nets only provide a single filter function. When the meshes of the two filter nets are larger, the juice yield is higher. But, they are unable to filter tiny fibers. The juice may have much pomace. When the meshes of the two filter nets are smaller, the juice yield is lower. This is disadvantageous to market competition.

### SUMMARY OF THE INVENTION

The present invention is to provide a dual-filter cutter rotary disc of a juicer, with a simple design to solve the problems existed in the prior art.

According to the present invention, there is provided a dual-filter cutter rotary disc of a juicer, which comprises a base coupled to the juicer. The base comprises two filter nets which are synchronously rotated along with the base and at least one cutter. The two filter nets are an inner filter net and an outer filter net. The two filter nets have meshes which are different in configuration, in shape and in size, so that the two filter nets have different operative filter areas.

Preferably, the meshes of the two filter nets have different distributed densities. The meshes of the outer filter net are denser than the meshes of the inner filter net.

Alternatively, the meshes of the two filter nets have different distributed densities. The meshes of the outer filter net are sparser than the meshes of the inner filter net.

Preferably, the meshes of the two filter nets have different filter areas, respectively. The filter area of each of the meshes of the outer filter net is larger than the filter area of each of the meshes of the inner filter net.

Alternatively, the meshes of the two filter nets have different filter areas, respectively. The filter area of each of the meshes of the inner filter net is larger than the filter area of each of the meshes of the outer filter net.

Preferably, the shape of the meshes of the two filter nets is one selected from a group consisting of circle, square, rectangle, diamond, crescent and irregular or any combination thereof.

Compared to the prior art, the present invention has obvious advantages and is benefic effects. The inner filter net and the outer filter net have different meshes in shape or in size to provide a dual-filter effect. The different filter nets can be separated for a desired filter, providing a better filter quality and decreasing the pomace in the juice.

### BRIEF DESCRIPTION OF THE DRAWINGS

FIG. 1a is a perspective view according to a first embodiment of the present invention;

FIG. 1b is a cross-sectional view according to the first embodiment of the present invention;

FIG. 2a is a schematic view showing the meshes of the inner filter net according to the first embodiment of the present invention;

FIG. 2b is a schematic view showing the meshes of the outer filter net according to the first embodiment of the present invention;

FIG. 3a is a schematic view showing the meshes of the inner filter net according to a second embodiment of the present invention;

FIG. 3b is a schematic view showing the meshes of the outer filter net according to the second embodiment of the present invention;

FIG. 4a is a schematic view showing the meshes of the inner filter net according to a third embodiment of the present invention;

FIG. 4b is a schematic view showing the meshes of the outer filter net according to the third embodiment of the present invention;

FIG. 5a is a schematic view showing the meshes of the inner filter net according to a fourth embodiment of the present invention;

FIG. 5b is a schematic view showing the meshes of the outer filter net according to the fourth embodiment of the present invention;

FIG. 6a is a schematic view showing the meshes of the inner filter net according to a fifth embodiment of the present invention; and

FIG. 6b is a schematic view showing the meshes of the outer filter net according to the fifth embodiment of the present invention.

### DETAILED DESCRIPTION OF THE PREFERRED EMBODIMENTS

Embodiments of the present invention will now be described, by way of example only, with reference to the accompanying drawings.

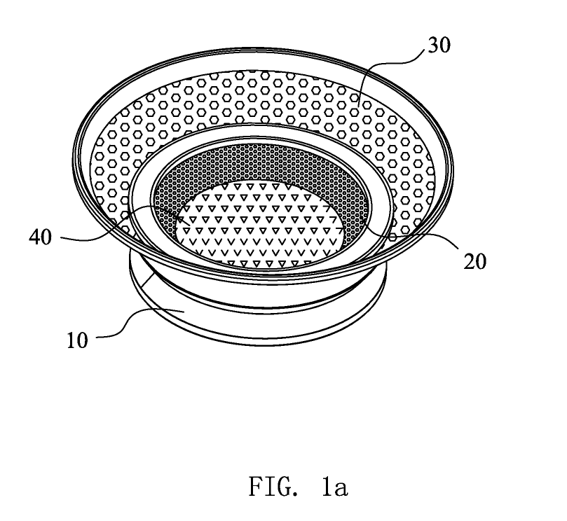

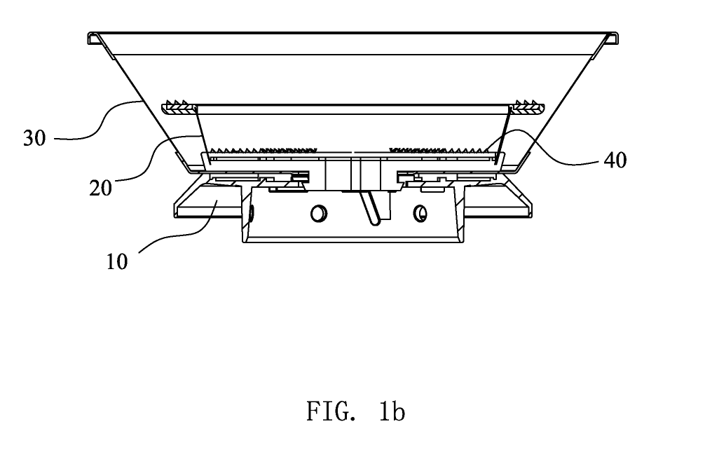

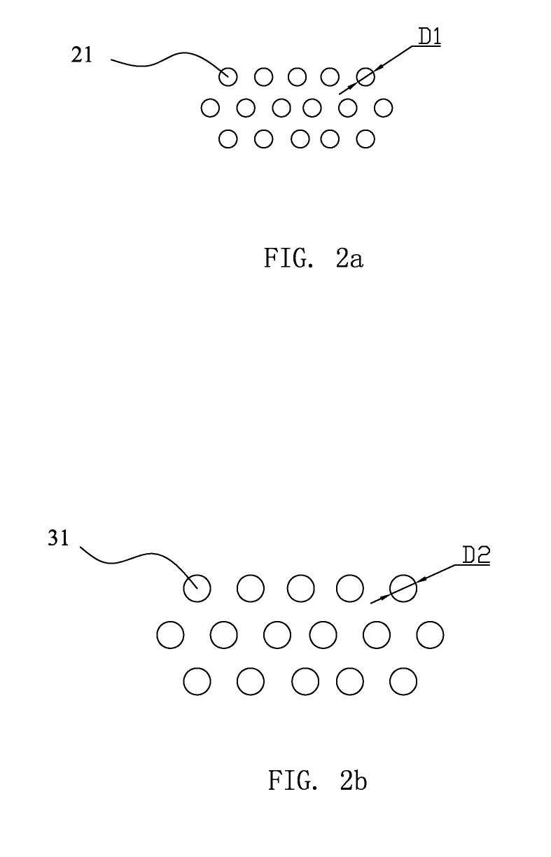

As shown in FIG. 1a and FIG. 1b, a first embodiment of the present invention comprises a base 10 coupled to a juicer. The base 10 comprises two filter nets 20, 30 which are synchronously rotated along with the base 10, and at least one cutter 40. The two filter nets 20, 30 are an inner filter net 20 and an outer filter net 30. The two filter nets 20, 30 have meshes which are different in configuration. As shown in FIG. 2a and FIG. 2b, the meshes 21, 31 of the two filter nets 20, 30 have the same shape but in different sizes. In this embodiment, the meshes 21, 31 of the two filter nets 20, 30 are circular. The mesh 31 of the outer filter net 30 has a diameter D2 which is larger than the diameter D1 of the mesh 21 of the inner filter net 20, so the two filter nets 20, 30 have different operative filter areas. The operative filter area of the outer filter net 30 is larger than the operative filter area of the inner filter net 20. In this way, the smaller mesh 21 of the inner filter net 20 can filter larger fibers, so the pomace in the juice is less. The mesh 31 of the outer filter net 30 can get a higher juice yield to keep the flavor of fruit. Hence, the present invention achieves a dual-filter effect. The different filter nets can be separated for a desired filter, providing a better filter efficiency and quality.

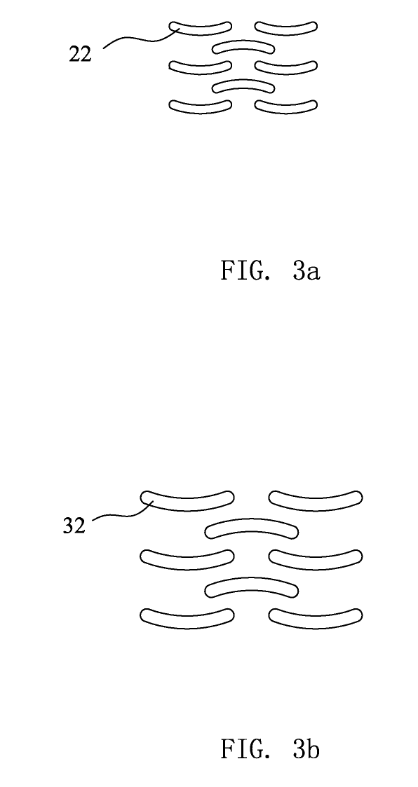

FIG. 3a and FIG. 3b show a second embodiment of the present invention, which is substantially similar to the first embodiment with the exceptions described hereinafter. The inner filter net 20 and the outer filter net 30 have crescent-like meshes 22, 32. The crescent-like mesh 32 of the outer filter net 30 is larger in size than the crescent-like mesh 22 of the inner filter net 20.

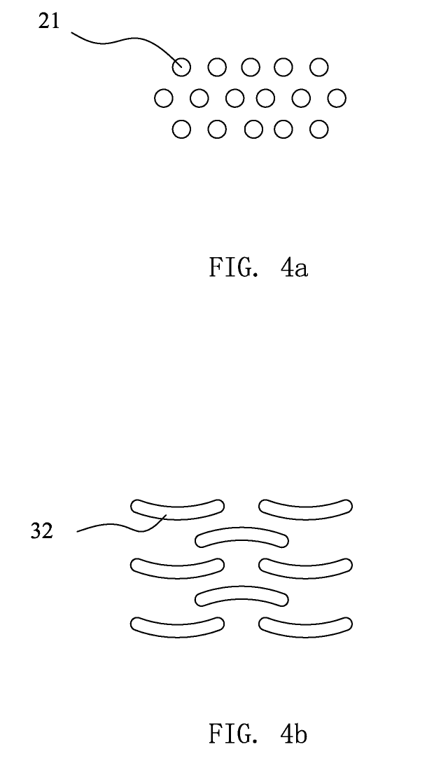

FIG. 4a and FIG. 4b show a third embodiment of the present invention, which is substantially similar to the first embodiment with the exceptions described hereinafter.

In this embodiment, the meshes of the inner filter net 20 and the outer filter net 30 have different shapes. The mesh 21 of the inner filter net 20 is circular, and the mesh 32 of the outer filter net 30 is crescent. The mesh 32 of the outer filter net 30 has a larger filter area than the mesh 21 of the inner filter net 20. By changing the is shape of the mesh, the filter capacity can be adjusted. Besides, the meshes of the inner filter net 20 and the outer filter net 30 have different arrangement configurations. As shown in the drawings, the meshes 21 are arranged side by side, and the meshes 32 are interlaced.

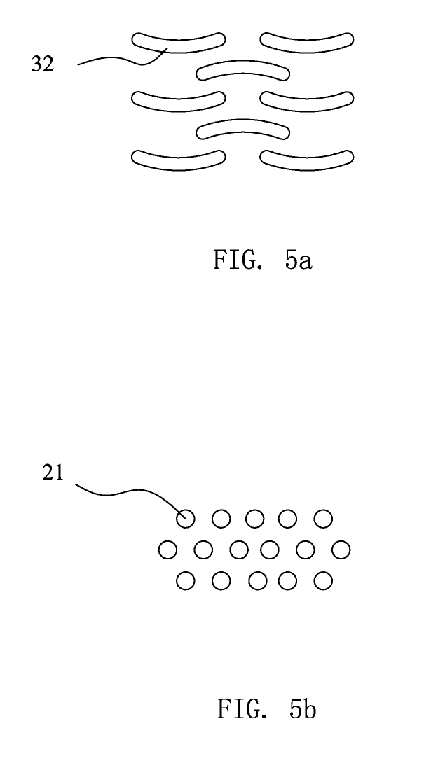

FIG. 5a and FIG. 5b show a fourth embodiment of the present invention, which is substantially similar to the third embodiment with the exceptions described hereinafter. In this embodiment, the meshes of the inner filter net 20 and the outer filter net 30 are interchanged. The mesh 32 of the inner filter net 20 is crescent, and the mesh 21 of the outer filter net 30 is circular. Therefore, the functions of the inner filter net 20 and the outer filter net 30 are interchanged.

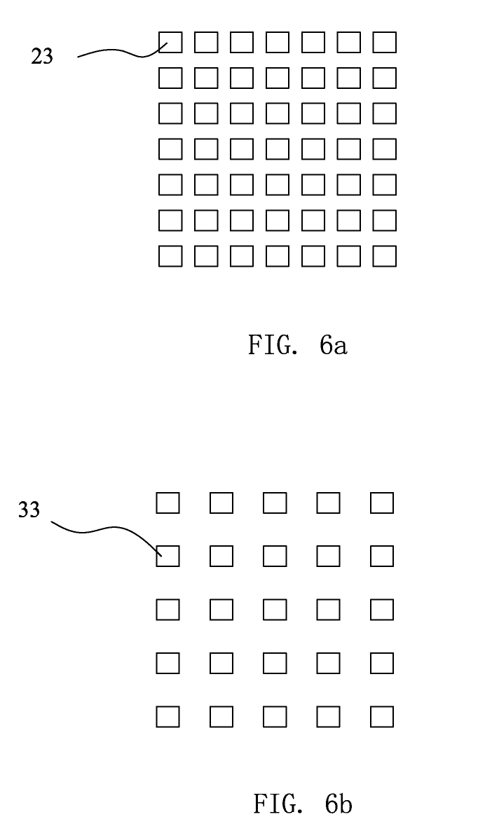

FIG. 6a and FIG. 6b show a fifth embodiment of the present invention, which is substantially similar to the first embodiment with the exceptions described hereinafter. In this embodiment, the meshes 23, 33 are square instead of the circular meshes 21, 31. The meshes 23, 33 of the inner filter net 20 and the outer filter net 30 have the same size, but in different arrangement configurations. In a measure unit, the number of the meshes 33 of the outer filter net 30 is less than that of the meshes 23 of the inner filter net 20. The operative filter area of the inner filter net 20 is larger than the operative filter area of the outer filter net 30.

It is noted that the shapes of the meshes are not limited to the circular meshes 21, 31, the crescent-like meshes 22, 32 and the square meshes 23, 33 as shown in the aforesaid embodiments. They may be one of rectangular, diamond, and irregular shape or a combination thereof.

The feature of the present invention is that the inner filter net and the outer filter net have different meshes in shape or in size to provide a dual-filter effect. The different filter nets can be separated for a desired filter, providing a better filter quality and decreasing the pomace in the juice.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A dual-filter cutter rotary disc of a juicer, comprising a base coupled to the juicer, the base comprising two filter nets which are synchronously rotated along with the base and at least one cutter, the two filter nets being an inner filter net and an outer filter net, characterized by: the two filter nets having meshes which are different in configuration, in shape and in size so that the two filter nets having different operative filter areas.

2. The dual-filter cutter rotary disc of a juicer as claimed in claim 1, wherein the meshes of the two filter nets have different distributed densities, the meshes of the outer filter net being denser than the meshes of the inner filter net.

3. The dual-filter cutter rotary disc of a juicer as claimed in claim 1, wherein the meshes of the two filter nets have different distributed densities, the meshes of the outer filter net being sparser than the meshes of the inner filter net.

4. The dual-filter cutter rotary disc of a juicer as claimed in claim 1, wherein the meshes of the two filter nets have different filter areas, respectively, the filter area of each of the meshes of the outer filter net being larger than the filter area of each of the meshes of the inner filter net.

5. The dual-filter cutter rotary disc of a juicer as claimed in claim 1, wherein the meshes of the two filter nets have different filter areas, respectively, the filter area of each of the meshes of the inner filter net being larger than the filter area of each of the meshes of the outer filter net.

6. The dual-filter cutter rotary disc of a juicer as claimed in claim 1, wherein the shape of the meshes of the two filter nets is one selected from a group consisting of circle, square, rectangle, diamond, crescent and irregular or any combination thereof.

7. The dual-filter cutter rotary disc of a juicer as claimed in claim 2, wherein the shape of the meshes of the two filter nets is one selected from a group consisting of circle, square, rectangle, diamond, crescent and irregular or any combination thereof.

8. The dual-filter cutter rotary disc of a juicer as claimed in claim 3, wherein the shape of the meshes of the two filter nets is one selected from a group consisting of circle, square, rectangle, diamond, crescent and irregular or any combination thereof.

9. The dual-filter cutter rotary disc of a juicer as claimed in claim 4, wherein the shape of the meshes of the two filter nets is one selected from a group consisting of circle, square, rectangle, diamond, crescent and irregular or any combination thereof.

10. The dual-filter cutter rotary disc of a juicer as claimed in claim 5, wherein the shape of the meshes of the two filter nets is one selected from a group consisting of circle, square, rectangle, diamond, crescent and irregular or any combination thereof.
